(19) United States
(12) Patent Application Publication
(10) Pub. No.: US 2009/0251800 A1
(43) Pub. Date: Oct. 8, 2009

(54) Camera Module

(76) Inventor: Yoshifumi Iwai, Nara (JP)

Correspondence Address: EDWARDS ANGELL PALMER & DODGE LLP, P.O. BOX 55874, BOSTON, MA, 02205, US

(21) Appl. No.: 12/225,484

(22) PCT Filed: Mar. 7, 2007
(86) PCT No.: PCT/JP2007/054430

§ 371 Date: Feb. 23, 2009

(30) Foreign Application Priority Data
Mar. 24, 2006 (JP) 2006-082364

(51) Int. Cl. G02B 7/04; G02B 7/02

(52) U.S. Cl. 359/704; 359/823

(57) ABSTRACT

On an outer peripheral portion of an adjusting lens holder (11), a ring-shaped first protrusion (12) is arranged to protrude to a housing (3). On an inner peripheral portion of the housing (3), a ring-shaped second protrusion (13) is arranged to protrude to the adjustment lens holder (11). The first protrusion (12) is arranged outside the second protrusion (13), an interval (B) between the both protrusions (12, 13) is smaller than a clearance (A) between the adjustment lens holder (11) and the housing (3), and the height of the first protrusion (12) is lower than that of the second protrusion (13). The minimum value of the clearance (A) is “A−B” and a space is provided between the first protrusion (12) adjacent to the clearance (A) and the housing (3). Thus, an adhesive is prevented from leaking out at the time of applying the adhesive in the clearance (A), and the space is filled with the adhesive. An optical system is prevented from breaking due to dropping impact by strongly fixing the adjusting lens holder (11) to the housing (3).

### BACKGROUND OF THE INVENTION

1. Technical Field

The present invention relates to a camera module including an optical system and an image pickup device.

2. Background Art

Camera modules incorporated into compact cameras, digital cameras, etc. are being sophisticated in functionality such as being configured to be capable of wide-angle shooting and telephoto shooting by coping with a large number of pixels of a few million pixels and having a scaling mechanism.

In general, camera modules are provided with an optical system having a plurality of lenses and a substrate on which an image pickup device is mounted. In addition, in camera modules sophisticated in functionality, wide-angle shooting and telephoto shooting are enabled by increasing the number of pixels of an image pickup device and/or changing positions of a plurality of lens holders that are combined with a plurality of lenses.

On the other hand, the need for reductions in size, thickness, and weight of camera modules has been increasing in order to cope with reductions in size and thickness of equipment, so that such a configuration as reducing the diameters of lenses used for the optical system of a camera module or reducing the thickness of the housing of a camera module has been adopted. As a result, a problem arises that a shock is given to a camera module when equipment is dropped and thereby the camera module itself is damaged.

Thus, for a high performance camera module, it is needed to secure the performance of an optical system corresponding to the high performance of the camera module and a configuration resistant to drop shock.

For example, high performance camera modules include the followings. In a “camera module” disclosed in JP2005-195663A (patent document 1), an optical system and mechanisms are formed with respect to a reference plane for installation of lenses which is provided on a housing. In other words, with regard to optics such as lenses and a lens transfer mechanism such as a motor, reference portions for automatic assembly of the lenses and the lens transfer mechanism are provided based on a reference plane for installation of the lenses provided on the housing, and then the lenses and the lens transfer mechanism are assembled.

However, the “camera module” disclosed in patent document 1 has a problem that an adjustment for securing the performance of the optical system cannot be made after the lenses and the lens transfer mechanism have been assembled.

Furthermore, “lens frame, lens barrel, and camera” disclosed in JP2004-190710A (patent document 2) are configured such that eccentricity adjustments of lenses are simply and easily made in order to realize a high performance module. More specifically, a lens holding member is composed of a holding section holding one lens stationarily and an elastic holding section holding other lenses in a movable state.

However, the “lens frame, lens barrel, and camera” disclosed in patent document 2 has a problem that even if the process of making eccentricity adjustments of lenses can be simplified, the elastic holding section is not suitable for installation on a small camera module because of the complicated configuration of it, thus leading to an increase in cost.

Furthermore, in any of patent documents 1 and 2, there is a problem that no shock-resistant configuration is considered.

A reduction in size and an increase in performance of a camera module are aimed at incorporation of the camera module into mobile equipment such as a digital camera and a cellular phone, and it is essential, in order to achieve the reduction in size and the increase in performance, to make an accuracy increasing structure as described above and make an eccentricity adjustment after assembling.

On the other hand, damage from drop is a big problem for the mobile equipment, and a camera module resistant to drop shock is needed. However, any of the optical systems in the patent documents is structured to fix lenses at three points or support them only by elastic deformation, without consideration of shock resistance.

### SUMMARY OF THE INVENTION

It is therefore an objective of the present invention to provide a small, high-performance camera module which can be prevented from being damaged by shock given from the outside by drop or the like.

A camera module according to the present invention comprises:

an image pickup device;

an optical system guiding light from a subject onto the image pickup device; and

a housing holding the optical system,

wherein:

the optical system includes an adjustment lens and an adjustment lens holder holding the adjustment lens;

the housing has a hole for passing light from the adjustment lens at a portion at which the housing holds the adjustment lens holder;

an outer peripheral portion of the adjustment lens holder is laid above a portion of the housing that surrounds the hole;

a first protrusion is provided on the outer peripheral portion of the adjustment lens holder, said first protrusion protruding toward the opposed housing and being shaped like a ring; and

a second protrusion is provided on the portion surrounding the hole of the housing, said second protrusion protruding toward the opposed adjustment lens holder and being shaped like a ring.

According to the above configuration, the first protrusion protruding toward the opposed housing is provided on the outer peripheral portion of the adjustment lens holder, and the second protrusion protruding toward the opposed adjustment lens holder is provided on the portion surrounding the hole of the housing. For this reason, when the adjustment lens holder is finely adjusted in horizontal directions to the housing, the minimum value of the clearance between the adjustment lens holder and the housing can be made larger than zero and a space can be provided between the outer peripheral portion of the adjustment lens holder and the portion surrounding the hole of the housing which are adjacent to the clearance and face each other. Thus, adhesive can be prevented from overflowing from the clearance when the adjustment lens holder is fixed to the housing after the fine adjustment. In addition, adhesive applied to the clearance can be filled in the space between the adjustment lens holder and the housing.

In other words, according to this embodiment, the adjustment lens holder can be strongly fixed to the housing after the fine adjustment of the adjustment lens, so that a camera module which does not vary in optical performance by shock by drop or the like can be obtained.

In one embodiment, the first protrusion is located outside the second protrusion.

According to this embodiment, the first protrusion provided on the adjustment lens holder is located outside the second protrusion provided on the housing. For this reason, the adjustable range of the adjustment lens holder at the fine adjustment is restricted by existence of the second protrusion, and the minimum value of the clearance between the adjustment lens holder and the housing becomes “A−B” which is the difference between the length A of the clearance and the interval B between the first protrusion and the second protrusion. Thus, adhesive can be prevented from overflowing from the clearance when the adhesive is applied in the clearance after the fine adjustment.

In other words, according to this embodiment, the adjustment lens holder can be strongly fixed to the housing with a small quantity of adhesive.

In one embodiment, the second protrusion is in contact with the outer peripheral portion of the adjustment lens holder.

According to this embodiment, the accuracy of the surface of the second protrusion is increased and a plane passing through the surface is assumed to be a reference plane, and thereby an accurate fine adjustment of the adjustment lens can be made by moving the adjustment lens holder in parallel with the reference plane along the reference plane. In addition, the second protrusion can be brought into intimate contact with the adjustment lens holder to prevent adhesive applied to the clearance from entering the inside of the camera module.

In one embodiment, at least one of an outer peripheral portion surface and an inner peripheral portion surface of the first protrusion is inclined.

According to this embodiment, at least one of the outer peripheral portion surface and the inner peripheral portion surface of the first protrusion provided on the adjustment lens holder is inclined, and thereby the adjustment lens holder can be fixed more strongly to the housing with adhesive. Thus, a camera module more resistant to shock by drop or the like can be obtained.

In one embodiment, the adjustment lens holder is held by a portion facing the image pickup device of the housing.

According to this embodiment, the fine adjustment of the optical system can be made with good operability by assuming a lens nearest to the subject of lenses constituting the optical system to be the adjustment lens.

In one embodiment, the optical system (2) includes at least one movable lens and a movable lens holder holding the movable lens; and

a transferring mechanism transferring the movable lens holder in a direction of an optical axis of the optical system is provided to give a magnification changing function to the optical system.

According to this embodiment, a camera module can be obtained in which the optical performance of an optical system sophisticated in functionality having a scaling function does not vary by shock by drop or the like.

### EFFECT OF THE INVENTION

As is apparent from the above, the camera module of the present invention has the first protrusion protruding toward the opposed housing that is provided on the outer peripheral portion of the adjustment lens holder, and the second protrusion protruding toward the opposed adjustment lens holder that is provided on the portion surrounding the hole of the housing. Therefore, when the adjustment lens holder is finely adjusted in horizontal directions to the housing, the minimum value of the clearance between the adjustment lens holder and the housing can be made larger than zero and a space can be provided between the outer peripheral portion of the adjustment lens holder and the portion surrounding the hole of the housing which are adjacent to the clearance and face each other. Thus, adhesive can be prevented from overflowing from the clearance when the adjustment lens holder is fixed to the housing after the fine adjustment. In addition, adhesive applied to the clearance can be filled in the space between the adjustment lens holder and the housing.

Thus, according to the present invention, the adjustment lens holder can be strongly fixed to the housing after the fine adjustment of the adjustment lens, so that a camera module which does not vary in optical performance by shock by drop or the like can be obtained.

### BRIEF DESCRIPTION OF THE DRAWINGS

FIG. 1 is a cross-sectional view showing the overall configuration of a camera module according to the present invention;

FIG. 2 shows a rough configuration of an adjustment lens, an adjustment lens holder, and a housing in FIG. 1;

FIG. 3 shows a rough configuration of an adjustment lens, an adjustment lens holder, and a housing of a conventional camera module;

FIG. 4 illustrates a method of orthogonalizing a reference plane and an optical axis to each other; and

FIG. 5 illustrates a method of matching the optical axis of an optical system to the center of an image pickup device.

### DETAILED DESCRIPTION OF THE INVENTION

The present invention will be described in detail below with an embodiment shown in the drawings. FIG. 1 is a cross-sectional view showing the overall configuration of the camera module of this embodiment.

As shown in FIG. 1, the camera module 1 is roughly composed of an optical system 2 realizing optical high performance, a housing 3 holding the optical system 2, and an image pickup device 4 detecting light from the optical system 2. The optical system 2 has a scaling (i.e., magnification change) function and is composed of a movable lens 5 which enables wide angle shooting and telephoto shooting and is capable of focus adjustment, a fixed lens 6, and an adjustment lens 7. The adjustment lens 7 is for realizing eccentricity adjustment work performed to secure optical high performance after assembling the movable lens 5 and the fixed lens 6.

Each of the movable lens 5, the fixed lens 6, and the aliment lens 7 is drawn as one lens in FIG. 1, but may be composed of a plurality of lenses as appropriate if necessary for realizing optical high performance.

Next, components constituting the camera module 1 will be described.

The sizes of the optical system 2 and image pickup device 4 of the camera module 1 are restricted by the size of electronic equipment such as a cellular phone or an information terminal into which the camera module 1 is incorporated. Furthermore, the optical system 2 may be configured to be most suitable for the image pickup device 4 by optical design. As the image pickup device 4, a charge coupled device (CCD), a complementary metal oxide semiconductor (CMOS), or the like matched to a necessary number of pixels is used.

Lenses (such as the movable lens 5, the fixed lens 6, and the adjustment lens 7) are made of glass, plastic, or the like by shaving and/or molding. The lenses are optimized in shape by optical design of an optical system with a plurality of lenses, thus being formed as spherical lenses or aspherical lenses. In addition, in order to fix a lens to a plane provided on a lens holder or the housing for the accuracy of alignment of the optical system, a planar edge normal to the axis of the lens is formed around the outer peripheral portion of the lens as necessary.

When the movable lens 5 is capable of zooming and focusing, it is composed of a plurality of lenses performing zooming and focusing held by the movable lens holder 8. Specifically, the movable lenses 5 held by the movable lens holder 8 are assembled and adjusted so as to control the amount of eccentricity and fixed to the movable lens holder 8 with adhesive or the like.

In addition, in order to slide the movable lens holder 8 holding the movable lenses 5 along the optical axis 9 of the camera module 1, a sliding mechanism (not shown) for sliding the movable lens holder 8 along shafts 10 or cams (not shown) by a stepping motor (not shown) is provided as appropriate.

Lens holders such as the movable lens holder 8 and an adjustment lens holder 11 holding the adjustment lens 7 are formed by molding resin such as acrylonitrile butadiene styrene (ABS), polycarbonate, or liquid crystal polymer and performing work such as cut of the resin. It is desirable that the resin used in this case has rigidity so as not to be deformed or damaged by drop shock. In small electronic equipment in particular, assuming that a person carries it, it is necessary for the lens holders to be resistant to drop shock so as not to be damaged when the equipment is dropped from a height where the person holds it by the hand. For this reason, the lens holders are made in shapes resistant to shock by identifying possible large-deformation portions and easily damageable portions by a shock analysis and increasing the thicknesses of the identified portions and/or adding ribs to the identified portions.

Furthermore, the optical system 2 and the image pickup device 4 are mounted on the housing 3 formed by molding resin such as ABS, polycarbonate, or liquid crystal polymer and/or performing work such as cutting of the resin, and constitute the camera module 1. A portion holding the adjustment lens holder 11 of the housing 3 is provided in a position facing the image pickup device 4. A hole passing light from the adjustment lens 7 is bored in the portion holding the adjustment lens holder 11 of the housing 3, and the outer peripheral portion of the adjustment lens holder 11 is laid above a portion surrounding the hole of the housing 3.

A camera module having a zoom optical system capable of scaling is described above. However, a single focus camera module incapable of scaling also has a similar configuration. In other words, the single focus camera module is different from the described camera module 1 only in that the former does not include movable portions such as the movable lens 5 (and the movable lens holder 8) and shafts 10, and is similar to the camera module 1 in that lenses are arranged in positions decided by optical design to realize its high performance.

The adjustment lens 7, the adjustment lens holder 11, and an eccentricity adjustment method for the camera module 1 will be specifically described below.

[Configuration of Adjustment Lens 7 and Adjustment Lens Holder 11]

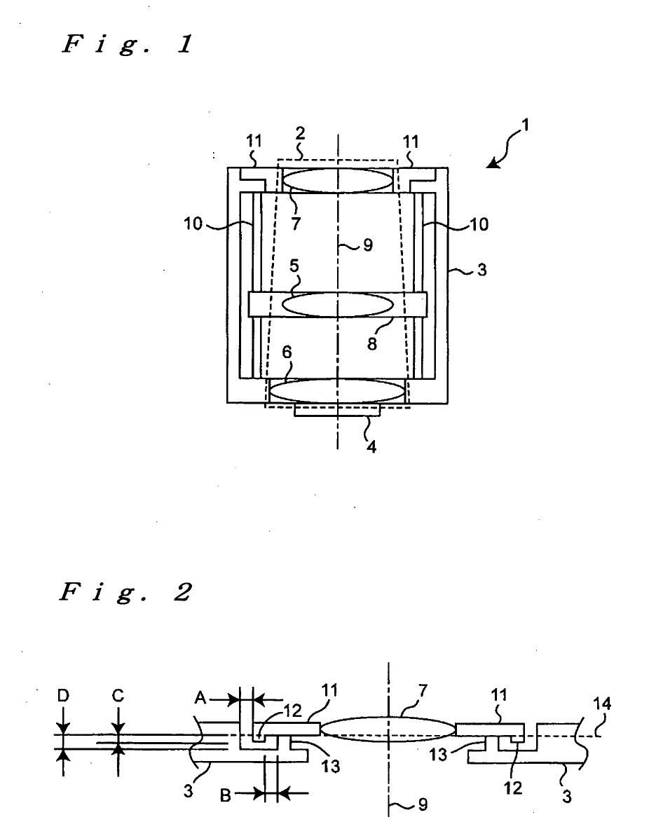

FIG. 2 shows a rough configuration of the adjustment lens 7, the adjustment lens holder 11, and the housing 3 in this embodiment. FIG. 3 shows a conventional configuration for comparison. In FIGS. 2 and 3, the same numbers are attached to similar components. The superiority of the configuration of this embodiment over the conventional configuration will be described below according to FIGS. 2 and 3.

First, the conventional configuration will be described according to FIG. 3. In a camera module 15, an eccentricity adjustment (i.e. alignment) process is absolutely necessary for realizing high performance. The eccentricity adjustment process is a process performed after assembling an optical system from lenses, etc. and assembling a lens transfer mechanism from a motor, etc. to make the performance of the optical system higher by finely adjusting the location of the adjustment lens 7. In general, in the state after an optical system has been assembled from lenses, etc. and a lens transfer mechanism has been assembled from a motor, etc., an error by assembling arises after all. The error is a cause deteriorating the lens performance. For this reason, by finely adjusting the location of some lens (the adjustment lens 7 in this case) of the optical system, the performance of the optical system can be made higher. Thus, the lens performance is restored and the high performance optical system of the camera module 15 is obtained by fixing the adjustment lens holder 11 to the housing 3 with adhesive or the like after finely adjusting the adjustment lens 7.

In the eccentricity adjustment process of the conventional camera module 15, as shown in FIG. 3, the contact surface between the housing 3 and the adjustment lens holder 11 fixing the adjustment lens 7 is used as a reference plane 16 for adjustment. And the adjustment lens holder 11 to which the adjustment lens 7 is attached is finely adjusted in horizontal directions along the reference plane 16 so as to obtain a high performance optical system.

In general, as the camera module 15 is reduced in size, parts of it become smaller, and a clearance provided for adjustment becomes smaller accordingly. For example, in the case of the camera module 15 incorporated into a cellular phone or an information terminal, the clearance A between the adjustment lens holder 11 and the housing 3 in FIG. 3 is only of the order of 0.5 mm. Thus, when the adjustment lens holder 11 is fixed to the housing 3 by applying ultra violet cure adhesive or the like to the clearance A after the fine adjustment of the adjustment lens holder 11, a sufficient amount of application of the adhesive cannot be secured. For this reason, sufficient fixing strength cannot be obtained between the adjustment lens holder 11 and the housing 3. In addition, when the clearance A becomes about 0 mm as a result of the fine adjustment of the adjustment lens holder 11, adhesive applied to the clearance A overflows to the surface and does not contribute to fixation of the adjustment lens holder 11 to the housing 3. In other words, the fixation of the adjustment lens holder 11 to the housing 3 becomes uneven.

As a result, in a reliability test such as a drop shock test, the adjustment lens holder 11 comes off the housing 3 or the position of the adjustment lens holder 11 varies by damage of the adhesive, which becomes a factor deteriorating the optical performance of the camera module 15.

In addition, when adjusting the adjustment lens holder 11, the clearance A between the adjustment lens holder 11 and the housing 3 almost disappears and thereby the adhesive overflows on the surface, or, when the adjustment is continued, the adhesive flows partially between the adjustment lens holder 11 and the reference plane 16 of the housing 3, which causes a problem that the adjustment lens holder 11 inclines relative to the reference plane 16 of the housing 3.

For this reason, in the camera module 1 of this embodiment, a first protrusion 12 protruding toward the opposed housing 3 is provided on the outer peripheral portion of the adjustment lens holder 11 as shown in FIG. 2. On the other hand, a second protrusion 13 protruding toward the opposed adjustment lens holder 11 is provided on a portion (referred to as “inner peripheral portion” herein after) surrounding the hole of the housing 3. The first protrusion 12 and the second protrusion 13 are each shaped like a ring which is substantially concentric with the adjustment lens 7, and the radius of the first protrusion 12 is larger than the radius of the second protrusion 13. In other words, the second protrusion 13 is located inside the first protrusion 12.

However, it is desirable that the camera module 1 is small. Thus, the first protrusion 12 and the second protrusion 13 may be cut according to the size of the camera module 1. For example, when the shell structure of the camera module 1 is a rectangular parallelepiped, parts on sides of two long sides of the rectangular parallelepiped may be cut off the first protrusion 12 and the second protrusion 13 by the same size with respect to a plane which divides the long sides of the shell into two. Even in such a case, there is no problem in particular in constituting the camera module 1.

In this embodiment, a plane passing through a top surface of the second protrusion 13 is used as a reference plane 14.

In the above configuration, it is desirable that the interval B between the first protrusion 12 and the second protrusion 13 is made smaller than the clearance A between the housing 3 and the adjustment lens holder 11. In this way, the adjustable range of the adjustment lens holder 11 is limited, and the minimum value of the clearance A between the adjustment lens holder 11 and the housing 3 becomes “A−B” which is the difference between the clearance A and the interval B. Thus, adhesive can be prevented from overflowing from the clearance A when the adjustment lens holder 11 is fixed to the housing 3 by applying the adhesive to the clearance A after the fine adjustment of the adjustment lens holder 11.

In addition, in this embodiment, the first protrusion 12 and the second protrusion 13 are made different in height in order to strongly fix the adjustment lens holder 11 to the housing 3. In other words, when the height of the first protrusion 12 provided on the adjustment lens holder 11 is C and the height of the second protrusion 13 provided on the housing 3 is D, C<D. In this way, a space can be provided between the first protrusion 12, which is located adjacent to the clearance A, and the housing 3, and adhesive applied to the clearance A can be filled in a region which is outside the second protrusion 13 and is between the adjustment lens holder 11 and the housing 3 facing each other. Thus, the adjustment lens holder 11 can be bonded and fixed to the housing 3 more strongly and the camera module 1 which does not vary in optical performance by drop shock can be thus obtained.

In contrast to this, as described above, the configuration of the conventional camera module 15 as shown in FIG. 3 has a problem that the clearance A is narrow and there is no space in which adhesive can be filled in a region between the adjustment lens holder 11 and the housing 3 facing each other so that adhesive applied to the clearance A overflows, and a problem that adhesive flows partially between the adjustment lens holder 11 and the reference plane 16 of the housing 3, that is, so-called throwing power arises, at a fine adjustment.

As described above, in this embodiment, the first protrusion 12 protruding toward the opposed housing 3 is provided on the outer peripheral portion of the adjustment lens holder 11. Thus, as compared with the case that the first protrusion 12 is not provided (in other words, only the second protrusion 13 is provided), there are advantageous effects such as:

(1) The contact area between the housing 3 and the lens holder 11 increases, providing a structure resistant to drop shock;

(2) The fine adjustment range of the adjustment lens holder 11 can be restricted; and

(3) The amount of adhesive can be reduced by the first protrusion 12.

Since the amount of adhesive applied can be adequate by these effects, in the camera module 1, it can be suppressed that excessive adhesive overflows and the throwing power arises, and therefore strong fixation of the adjustment lens holder 11 can be realized with a small amount of adhesive. If the first protrusion 12 is not provided on the outer peripheral portion of the adjustment lens holder 11, the amount of adhesive applied increases accordingly and the adhesive tends to flow partially and applied between the second protrusion 13 of the housing 3 and the adjustment lens holder 11 at a fine adjustment.

By the way, as adhesive in this embodiment, thermosetting adhesive having curability with ultra violet may be used. The reason is that adhesive filled in a space under the adjustment lens holder 11 cannot be cured with ultra violet. For this reason, when thermosetting adhesive having curability with ultra violet is used, the adhesive in the clearance A between the adjustment lens holder 11 and the housing 3 can be cured with ultra violet and then the adhesive under the adjustment lens holder 11 can be cured with heat in an oven or the like, so that the camera module 1 keeping optical performance after the fine adjustment can be obtained.

As described above, the camera module 1 of this embodiment is able to improve the above problem of the conventional camera module 15 and thus satisfy the optical performance.

[Eccentricity Adjustment Method]

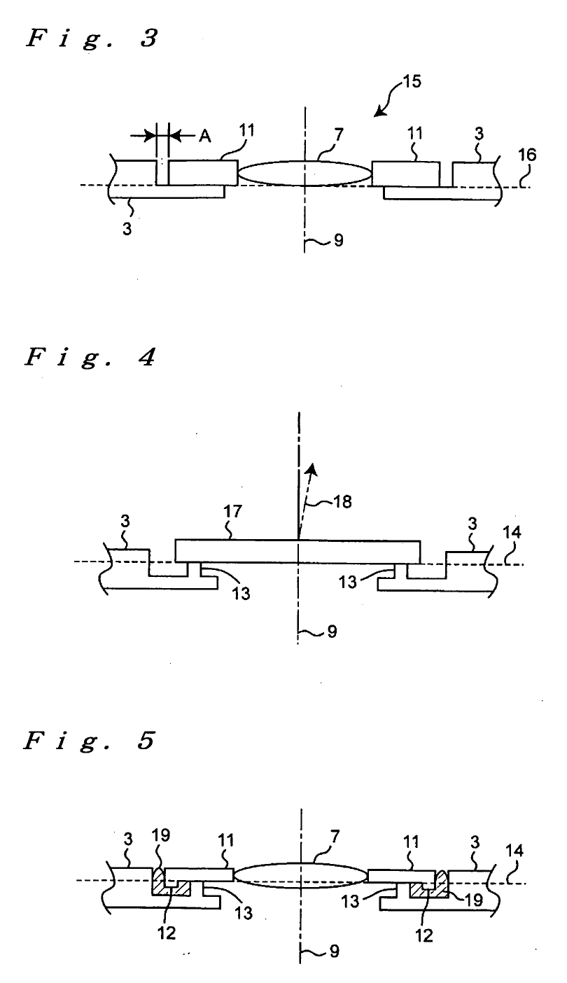

Next, an eccentricity adjustment (alignment) method of the camera module 1 will be described according to FIGS. 4 and 5.

In the eccentricity adjustment method, centering of the image pickup device 4 (see FIG. 1) and setting of a reference axis of the image pickup device 4 are performed first. Next, centering of the camera module 1 and setting of a reference axis of the camera module 1 are performed. By these settings, the reference axis (optical axis) 9 and the reference plane 14 in the camera module 1 become normal to each other. The optical axis 9 can be set by using a semiconductor laser, a He—Ne laser, or the like as a light source and detecting reflected light from a reflecting surface of a half mirror or the like.

More specific description will be given below. As shown in FIG. 4, a reflection plane 17 constituted by quartz glass or the like is put on the second protrusion 13 provided on the inner peripheral portion of the housing 3, and the posture of the camera module 1 is adjusted as appropriate so that reflected light 18 from the reflection plane 17 agrees with the reference axis (optical axis) 9. In this way, the reference plane 14 passing through the top surface of the second protrusion 13 and the optical axis 9 come to be orthogonal to each other. In addition, the posture of the camera module 1 is adjusted as appropriate so that a light beam which has passed through the optical system (excluding the adjustment lens 7) of the camera module 1 goes through the center of the image pickup device 4. As a result, the optical axis of the image pickup device 4 agrees with the optical axis 9 of the camera module 1.

Next, as shown in FIG. 5, the adjustment lens 7 is mounted to the adjustment lens holder 11, which is then displaced in horizontal directions along the reference plane 14 and is finely adjusted so that a light beam which has passed through the optical system 2 including the adjustment lens 7 comes to the center of the image pickup device 4.

By this fine adjustment, the adjustment of the optical system 2 of the camera module 1 is almost completed. In addition, in order to make an adjustment for other than the axis of the optical system, the image pickup device 4 may be finely adjusted using a chart (not shown) placed at a fixed distance from the camera module 1. In this case, it becomes possible to build the camera module 1 with most suitable image balance by adjusting the image pickup device 4 using the chart.

In the configuration of the adjustment lens 7, the adjustment lens holder 11, and the housing 3 of the conventional camera module 15 shown in FIG. 3, the contact surface between the adjustment lens holder 11 and the housing 3 is used as the reference plane 16. On the other hand, in the configuration of the adjustment lens 7, the adjustment lens holder 11, and the housing 3 of the camera module 1 of this embodiment, a plane passing through the top of the second protrusion 13 provided on the housing 3 is used as the reference plane 14 as shown in FIG. 2. In other words, because the second protrusion 13 is provided on the housing 3, the adjustment lens holder 11 does not come into direct contact with the housing 3, so that a contact surface between the adjustment lens holder 11 and the housing 3 cannot be used as a reference plane. For this reason, the surface of the second protrusion 13 provided on the housing 3 is increased in accuracy to be the reference plane 14, and thereby an accurate fine adjustment of the adjustment lens 7 using the reference plane 14 can be made as in the case of the conventional camera module 15 shown in FIG. 3.

In addition, the second protrusion 13 has an effect in preventing adhesive 19 applied to the clearance A from entering the inside of the camera module 1.

Furthermore, in the eccentricity adjustment method described above, the camera module 1 may be made in such a way that the image pickup device 4 is adjusted after the eccentricity adjustment of the adjustment lens 7 and is then fixed to the housing 3 with adhesive or the like. In this case, the “eccentricity adjustment of the optical system 2” and the “adjustments of the image pickup device 4 and the optical system 2” can be made at the same time, so that the process can be shortened.

Furthermore, in the eccentricity adjustment method described above, a two-step adjustment process may be provided in which first only the eccentricity adjustment of the optical system 2 by the adjustment lens 7 is made and then adjustments of the image pickup device 4 and the optical system 2 are made. In this case, the image pickup device 4 to be used may be a master image pickup device serving as a basis of the camera module 1, and the optical system 2 in which only the adjustment lens 7 has been adjusted may have about the same optical performance as that of an optical system for which the “eccentricity adjustment of the optical system” and the “adjustments of the image pickup device and the optical system” have been made.

In any of the above cases of the eccentricity adjustment method, it is desirable that the adjustment lens 7 is located at one of two ends of the optical system 2 in a position opposite from the image pickup device 4 with respect to the housing 3. In other words, in the camera module 1, a sufficient space necessary for an adjustment mechanism can be secured by using a lens near a subject as the adjustment lens 7, so that the performance of the optical system 2 can be easily adjusted.

As described above, the camera module 1 of this embodiment has the optical system 2 composed of the movable lens 5 to which a focus adjustment can be made, the fixed lens 6, and the adjustment lens 7, and the adjustment lens 7 is held by the adjustment lens holder 11. The optical system 2 and the lens transfer mechanism are assembled and then the adjustment lens holder 11 holding the adjustment lens 7 is finely adjusted in a horizontal direction along a reference plane and is fixed to the housing 3, so that the high performance optical system is obtained.

At that time, the ring-shaped first protrusion 12 centering the optical axis 9 protruding toward the opposed housing 3 is provided on the outer peripheral portion of the adjustment lens holder 11. On the other hand, the ring-shaped second protrusion 13 centering the optical axis 9 protruding toward the opposed adjustment lens holder 11 is provided on the inner peripheral portion of the housing 3. The radius of the ring-shaped first protrusion 12 is made larger than the radius of the ring-shaped second protrusion 13, and a plane passing through the top surface of the second protrusion 13 is assumed to be the reference plane 14.

In addition, the interval B between the first protrusion 12 and the second protrusion 13 is made smaller than the clearance A between the adjustment lens holder 11 and the housing 3, and the height of the first protrusion 12 on the adjustment lens holder 11 is made smaller than the height of the second protrusion 13 on the housing 3. In this way, the minimum value of the clearance can be made “A−B”, and a space can be provided between the first protrusion 12 adjacent to the clearance A and the housing 3. Thus, adhesive can be prevented from overflowing from the clearance A when the adjustment lens holder is fixed to the housing 3 with the adhesive, and adhesive applied to the clearance A can be filled in a region between the adjustment lens holder 11 and the housing 3 facing each other.

In other words, according to this embodiment, the adjustment lens holder 11 can be bonded and fixed to the housing 3 strongly after being finely adjusted, and the camera module 1 which does not vary in optical performance by drop shock can be thus obtained.

In this embodiment, the shape of the cross section of the first protrusion 12 provided on the adjustment lens holder 11 is a rectangle as shown in FIGS. 2 and 5, but may be changed as necessary by inclining the outer peripheral portion surface or inner peripheral portion surface of the first protrusion 12 or by any other way. If the fixation by adhesive of the adjustment lens holder 11 to the housing 3 can be stronger by changing the shape of the cross section of the first protrusion 12 and/or roughing the surface of the first protrusion 12, the camera module 1 more resistant to drop shock can be obtained.

Furthermore, in this embodiment, the adjustment lens 7 is held by the adjustment lens holder 11, but the adjustment lens holder 11 may not be used. In other words, when a molded lens or a hybrid lens with a resin layer formed on its surface is used, a protrusion can be provided on the lens surface. For this reason, when the adjustment lens 7 is a molded lens or a hybrid lens, the first protrusion 12 can be provided directly on the adjustment lens 7, thus producing en effect similar to that in the case of using the adjustment lens holder 11 on which the first protrusion 12 is provided.

What is claimed is:

1. A camera module comprising:
an image pickup device (4);
an optical system (2) guiding light from a subject onto the image pickup device (4); and
a housing (3) holding the optical system (2),
wherein:
the optical system (2) includes an adjustment lens (7) and an adjustment lens holder (11) holding the adjustment lens (7);
the housing (3) has a hole for passing light from the adjustment lens (7) at a portion at which the housing holds the adjustment lens holder (11);
an outer peripheral portion of the adjustment lens holder (11) is laid above a portion of the housing (3) that surrounds the hole;
a first protrusion (12) is provided on the outer peripheral portion of the adjustment lens holder (11), said first protrusion (12) protruding toward the opposed housing (3) and being shaped like a ring; and
a second protrusion (13) is provided on the portion surrounding the hole of the housing (3), said second protrusion protruding toward the opposed adjustment lens holder (11) and being shaped like a ring.

2. The camera module as claimed in claim 1, wherein the first protrusion (12) is located outside the second protrusion (13).

3. The camera module as claimed in claim 1, wherein the second protrusion (13) is in contact with the outer peripheral portion of the adjustment lens holder (11).

4. The camera module as claimed in claim 1, wherein at least one of an outer peripheral portion surface and an inner peripheral portion surface of the first protrusion (12) is inclined.

5. The camera module as claimed in claim 1, wherein the adjustment lens holder (11) is held by a portion facing the image pickup device (4) of the housing (3).

6. The camera module as claimed in claim 1, wherein:
the optical system (2) includes at least one movable lens (5) and a movable lens holder (8) holding the movable lens (5); and
a transferring mechanism transferring the movable lens holder (8) in a direction of an optical axis of the optical system (2) is provided to give a magnification changing function to the optical system (2).
